(19) United States
(12) Patent Application Publication
(10) Pub. No.: US 2014/0090733 A1
(43) Pub. Date: Apr. 3, 2014

(54) Adjustable Damping Valve Arrangement

(71) Applicant: Achim SAUERBREY, Schweinfurt (DE)

(72) Inventor: Achim SAUERBREY, Schweinfurt (DE)

(21) Appl. No.: 14/042,945

(22) Filed: Oct. 1, 2013

(30) Foreign Application Priority Data
Oct. 2, 2012 (DE) 10 2012 019 321.1

(51) Int. Cl. F16K 47/04

(52) U.S. Cl. CPC F16K 47/04
USPC 137/613

(57) ABSTRACT

An adjustable damping valve arrangement includes an actuator for controlling a main stage valve. The main stage valve has a rigid main stage valve body which carries out an axial operating movement relative to a valve seat surface of the main stage valve. A pre-opening valve having at least one spring element which in turn preloads a pre-opening valve body precedes the main stage valve body. The main stage valve body is supported on the valve seat surface in the closed operating position by the pre-opening valve. The pre-opening valve is divided by the valve seat surface into an inner pressure-impinged incident flow surface and an outer pressure-impinged incident flow surface. The inner pressure-impinged surface is operative for a first incident flow direction, and the outer pressure-impinged surface is operative for a second incident flow direction.

### BACKGROUND OF THE INVENTION

1. Field of the Invention

The invention is directed to an adjustable damping valve arrangement with an actuator for controlling a main stage valve having a rigid main stage valve body which carries out an axial movement relative to a valve seat surface of the main stage valve.

2. Background of the Invention

An adjustable damping valve arrangement is known from DE 10 2008 041 735 B3 in which a main stage valve can be controlled by an auxiliary valve. The main stage valve comprises a rigid main stage valve body which seats on a valve seat ring. When a flow impinges on the main stage valve body via a through-hole, the main stage valve body lifts from the valve seat ring so that damping medium can flow through the damping valve arrangement.

When flow impinges on the damping valve arrangement from the opposite direction via at least one radial opening, the valve seat ring lifts together with the main stage valve body from a valve seat surface on the housing side.

Under certain conditions, impact noises which are caused at least in part by the valve seat ring occur in the damping valve arrangement. To reduce noise, a permanent throttle opening is provided, e.g., by stamping the end face of the main stage valve body or the valve seat ring of the valve ring. Because of the delicate structural component parts, it is difficult to stamp a permanent throttle opening in a precise manner without damaging the structural component part itself.

A damping valve arrangement forming the basis for the damping valve arrangement according to Published Application US2011/168935A1 is known from U.S. Pat. No. 4,880,086. In addition to a rigid main stage valve body, U.S. Pat. No. 4,880,086 also discloses in FIG. 3 a variant having a diaphragm as main stage valve body. The diaphragm is fixed at its outer circumference and forms a main stage valve in the middle diameter region with a valve seat surface. This construction involves some disadvantages which have prevented this design principle from being generally accepted. For example, the diaphragm must execute the entire lifting path proceeding from the valve seat surface. With a diaphragm formed by a plate spring, for example, the plate spring characteristic has a very great influence on the lift behavior. There is also no axial support of the diaphragm to limit the lifting path and thereby increase durability.

An adjustable damping valve arrangement with a main stage valve is also known from DE 198 22 448 A1. Hydraulically and with respect to the spatial arrangement parallel to the main stage valve, a constant throttle cross section (FIG. 3) is used which cooperates in turn with a supplemental valve.

It is an object of the present invention to realize a damping valve arrangement in which the problem of noise is minimized.

### SUMMARY OF THE INVENTION

This object is met according to an embodiment of the invention in that a pre-opening valve having at least one spring element which in turn preloads a pre-opening valve body precedes the main stage valve body, wherein the main stage valve body is supported on the valve seat surface in the closed operating position by the pre-opening valve, wherein the pre-opening valve is divided by the valve seat surface into an outer pressure-impinged incident flow surface and an inner pressure-impinged incident flow surface, wherein the inner pressure-impinged surface is operative for a first incident flow direction and the outer pressure-impinged surface is operative for a second incident flow direction.

The great advantage of the invention consists in that impact noise is prevented on the one hand and discontinuity in the damping force characteristic is prevented on the other hand.

The spring element and the pre-opening valve body are advantageously combined in at least one flexible disk. In principle, a disk stack can also be used to adapt the operating behavior.

In a further advantageous embodiment, the valve seat surface is fixed in a stationary manner at a damping valve housing. An axially movable valve seat ring is often used in the prior art, but this structural component part is technically complicated to manufacture.

According to an advantageous embodiment, the main stage valve body has a supporting surface for the pre-opening valve, wherein an inner diameter of the supporting surface is greater than an outer diameter of the valve seat surface. The opening behavior of the pre-opening valve can be influenced independent from the design of the disk in the pre-opening valve by the dimensioning of the diameter. The larger the pressure-impinged surface, the lower the opening pressure for the pre-opening valve can be.

The spring element is advantageously centered radially relative to the main stage valve body by a positive engagement connection. The spring element and the flexible disk can execute an axial relative movement with respect to one another without the disk departing from a predetermined radial position.

The positive engagement connection is achieved in a very simple manner in that the main stage valve body has an axial centering projection which penetrates the pre-opening valve.

The centering projection has a greater axial penetration length than the lift path of the main stage valve body so that the centering function can be ensured regardless of the lift position of the main stage valve body.

By doing away with an axially movable valve seat ring, it is possible that the valve seat ring can be adjusted in its axial position relative to the damping valve housing. An operating position of the auxiliary valve can be adjusted more easily in this way.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described more fully referring to the following description of the drawings, in which:

FIG. 1 is a damping valve arrangement in a cross-sectional view; and

FIG. 2 is a detailed view of a section of FIG. 1.

### DETAILED DESCRIPTION OF THE PRESENTLY PREFERRED EMBODIMENTS

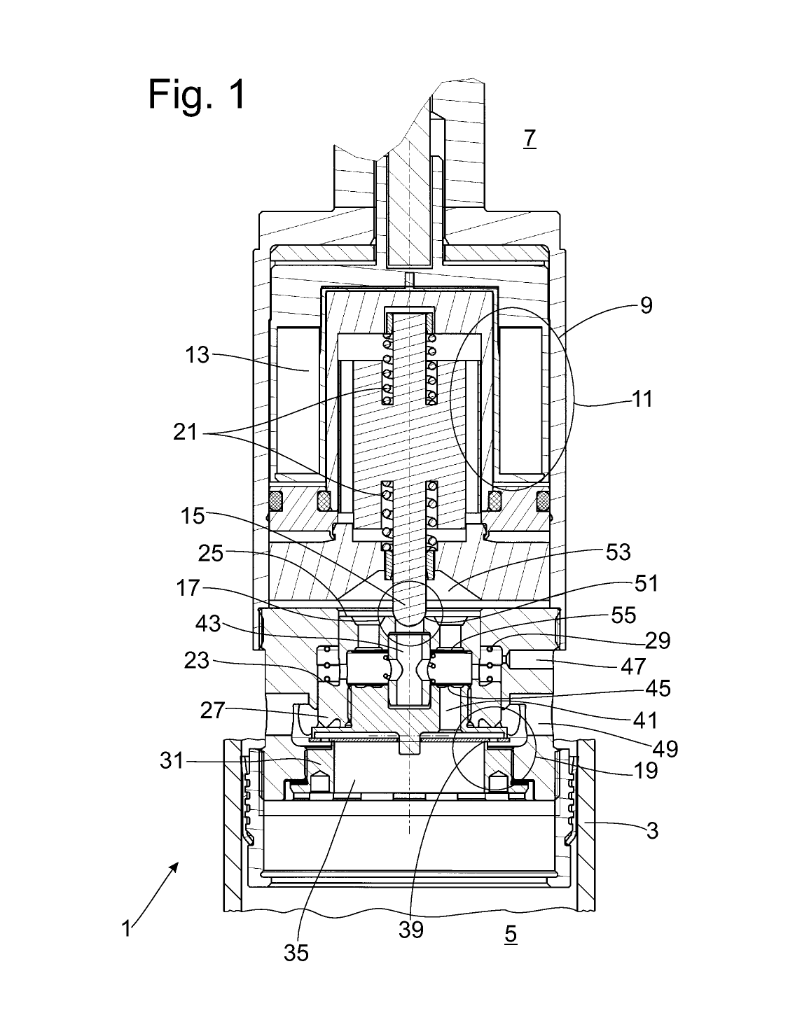

FIG. 1 shows a damping valve arrangement 1 for a vibration damper of any constructional type. The damping valve arrangement 1 can be arranged inside a cylinder 3 of the vibration damper between two working chambers 5; 7 as well as outside the cylinder 3 in a bypass line. An actuator 11 is arranged in a damping valve housing 9. In this example, the actuator 11 comprises a magnetic coil 13 which exerts an axial actuating force on an axially movable auxiliary valve body 15 of an auxiliary valve 17. The closing force can influence a main stage valve 19 by means of the auxiliary valve 17. The closing force is determined by the force of at least one valve spring 21, an actuating force of the actuator 11 opposing the valve spring force and a hydraulic closing force which is generated by the pressure on at least one pressure-impinged surface 23; 25 at a rigid main stage valve body 27.

The main stage valve body 27 is additionally preloaded by a main stage valve spring 29 on a valve seat ring 31 which is axially stationary with respect to the damping valve housing 9. The valve seat ring 31 has a first incident flow opening 35 for a first incident flow direction of the damping medium, which first incident flow opening 35 terminates in a valve seat surface 39 for the main stage valve body 27. The axial position of the valve seat ring 31 can be adjusted relative to the damping valve housing. Further, the basic setting of the damping valve arrangement can be adjusted, e.g., with respect to a defined opening cross section at the auxiliary valve 17 when the actuator 11 is inoperative, i.e., without power.

The main stage valve body 27 has at least one inlet channel 45 leading from the first incident flow opening 35 to a control space 43 to make use of the hydraulic pressure inside the damping valve arrangement 1 for generating a closing force on the main stage valve body 27. A check valve 41 at the end of the inlet channel 45 determines the flow direction in direction of the control space. A second inlet channel 47 likewise leads to the control space 43 hydraulically parallel to at least one second incident flow opening 49 for a second incident flow direction of the damping valve arrangement 1. An outlet cross section 51 of the control space 43 to a rear space 53 is determined by the auxiliary valve body 15 and with the latter forms the auxiliary valve 17. A second check valve 55 connects the rear space 53 of the auxiliary valve 17 to the control space 43 in order to minimize the hydraulic resistance during this opening movement of the main stage valve 19 as the volume of the rear space 53 decreases. The check valve 41 can also be constructed as a damping valve in order to influence the opening speed of the main stage valve 19.

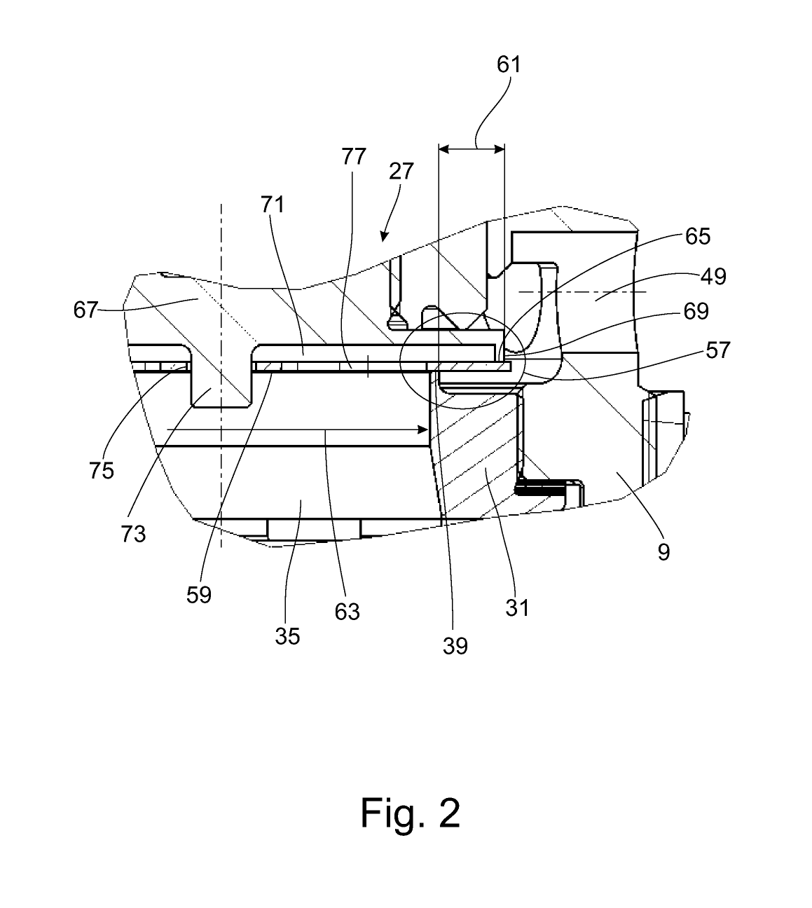

In addition to the auxiliary valve 17 and main stage valve 19, the damping valve arrangement 1 has a pre-opening valve 57 which has at least one spring element which in turn preloads a pre-opening valve body. It can be seen particularly in FIG. 2 that the spring element and the pre-opening valve body are combined in at least one flexible disk 59. The main stage valve body 27 is supported in the closed operating position of the main stage valve 19 on the flexible disk 59 and valve seat surface 39 by the pre-opening valve 57.

The pre-opening valve 57 or flexible disk 59 is divided by the valve seat surface 39 into an outer pressure-impinged incident flow surface 61 and an inner pressure-impinged incident flow surface 63, wherein the inner pressure-impinged incident flow surface 63 is operative for a first incident flow direction proceeding from the incident flow opening 35, and the outer pressure-impinged incident flow surface 61 is operative for a second incident flow direction via the second incident flow opening 49. To this end, the main stage valve body 27 has a supporting surface 65 for the pre-opening valve 57 and the flexible disk 59, respectively. An inner diameter of the supporting surface 65 is greater than an outer diameter of the valve seat surface 39. A valve insert 67 at the main stage valve body 27 has an outer annular web 69 which provides the supporting surface 65 and determines a free space 71 for the elastic deformation of the disk 59 in direction of the main stage valve body 27.

The spring element or flexible disk 59 is centered radially relative to the main stage valve body 27 by a positive engagement connection. The main stage valve body has an axial centering projection 73 which penetrates the pre-opening valve 57 in a centering opening 75. The positive engagement connection itself need not be formed centric to the main stage valve body 27. The positive engagement connection need merely limit a sideways movement of the flexible disk 59. The centering opening 75 also need not form a sealing location in direction of the main stage valve body 27. On the contrary, a passage proceeding from the incident flow opening 35 in direction of the main stage valve body 27 is desirable. If needed, the flexible valve disk can also have additional openings 77 in the region between the valve seat surface 39 and the centering opening.

Further, the centering projection has a greater axial penetration length inside the flexible disk 59 than the maximum possible lift path of the main stage valve body 27 from the flexible disk 59.

With incident flow in the main stage valve 19 proceeding from the first incident flow opening 35, the operating pressure is applied radially inside the valve seat surface 39 on the rigid inner region of the main stage valve body 27 and flexible disk 59.

Starting from the first incident flow opening 35, the damping medium flows along the inlet channel 41 in the main stage valve body 27 into the control space 43 and through the auxiliary valve 17 into the rear space 53. The pressure on the first annular pressure-impinged surface 23 and on a rear end face, as further pressure-impinged surface 25, and the resulting force on the auxiliary valve body 15 caused by the valve spring force, actuator force and the force of the main stage valve spring result in a closing force on the main stage valve body 27.

When the main stage valve 19 is closed, i.e., the main stage valve body 27 seats on the valve seat surface 39 together with the flexible valve disk 59, the damping medium flows further via the at least one centering opening 75 and/or at least one additional opening 77 on the underside of the main stage valve body 27. The pressure-impinged surface 59 between the inner diameter of the supporting surface 65 and the centering opening 75 at the flexible disk 59 is greater than the pressure-impinged surface between the centering opening 75 and the inner diameter of the valve seat surface 39. In this way, it is ensured in this incident flow direction that a contact between the valve seat surface 39 and the flexible disk 59 is guaranteed regardless of the pressure conditions. Depending on whether or not the actuator 11 is powered and on the position of the auxiliary valve 17 entailed thereby, the main stage valve body 27 lifts to a greater or lesser extent from the flexible disk 59 which remains on the valve seat surface 39 because of the above-described pressure-impinged surfaces.

By controlling the auxiliary valve 17 in a corresponding manner, the main stage valve 19 closes again. The flexible disk 59 of the pre-opening valve 57 then acts as a cushion to cushion the impact of the main stage valve body 27 on the valve seat surface 39 and accordingly at least minimizes an impact noise.

When the damping valve arrangement 1 is impinged via the radial second incident flow opening 49 (FIG. 1), the operating pressure is present at the edge side between the outer diameter of the valve seat surface 39 and the outer diameter of the supporting surface 65 at the main stage valve body 27. Depending on the dimensioning of the at least one flexible disk 59, this flexible disk can deform axially and release a cross section between the valve seat surface 39 and the disk 59 even before the main stage valve body 27 has executed a lifting movement. A pilot flow acts hydraulically in parallel via the second inlet channel 47 in the control space 43. The auxiliary valve 17 in turn determines the pressure level at the annular pressure-impinged surface 23 and the rear side 25 of the main stage valve body 27. There is at least one connecting channel, not shown, between the rear space 53 of the auxiliary valve 17 and the first incident flow opening 35 so that the pressure level in the rear space 53 can deviate from the pressure level in the control space 43. The check valve 41 is closed in direction of the first inlet channel 41, as is the check valve 55 between the rear space 53 and the control space 43.

During an opening movement of the main stage valve 19, the main stage valve body 27 lifts from the valve seat surface 39 along with the flexible disk 59. The hydraulic pressure at the flexible disk 59 provides for a permanent contact between the two structural component parts.

If a closing position of the main stage valve 19 is predetermined via the auxiliary valve 17, the pre-opening valve 57 likewise acts in a cushioning manner at the main stage valve body 27 in the simplified variant according to FIG. 1 because the flexible disk 59 acts as a spring between the valve seat ring 31 and the main stage valve body 27.

The valve seat surface 39 for the pre-opening valve 57 and the valve seat surface 39 for the main stage valve body 27 are identical when there is incident flow through the second incident flow opening 49.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. An adjustable damping valve arrangement comprising:
a main stage valve (19) having a valve seat surface (39) and a rigid main stage valve body (27) constructed for carrying out an axial operating movement relative to said valve seat surface (39) of said main stage valve (19);
a pre-opening valve (57) comprising a pre-opening valve body and at least one spring element which preloads said pre-opening valve body, said pre-opening valve preceding said main stage valve body (27); wherein said main stage valve body (27) is supported on said valve seat surface (39) in the closed operating position by said pre-opening valve (57); wherein said pre-opening valve (57) is divided by said valve seat surface into an inner pressure-impinged incident flow surface and the pre-opening valve is divided by the valve seat surface into an inner pressure-impinged incident flow surface and an outer pressure-impinged incident flow surface; and
wherein the inner pressure-impinged surface is operative for a first incident flow direction and the outer pressure-impinged surface is operative for a second incident flow direction.

2. The adjustable damping valve arrangement according to claim 1, wherein said spring element and said pre-opening valve body are combined in at least one flexible disk (59; 67).

3. The adjustable damping valve arrangement according to claim 1, additionally comprising a damping valve housing (9); and wherein said valve seat surface (39) is fixed to said damping valve housing (9) in a stationary manner.

4. The adjustable damping valve arrangement according to claim 1, wherein said spring element is centered radially relative to said main stage valve body (27) by a positive engagement connection.

5. The adjustable damping valve arrangement according to claim 4, wherein said main stage valve body (27) comprises a supporting surface (65) for said pre-opening valve (57); and wherein an inner diameter of said supporting surface (65) is greater than an outer diameter of said valve seat surface (39).

6. The adjustable damping valve arrangement according to claim 5, wherein said main stage valve body (27) comprises an axial centering projection (73) which penetrates said pre-opening valve (57).

7. The adjustable damping valve arrangement according to claim 6, wherein said main stage valve (27) has a lift path and wherein said centering projection (73) has a greater axial penetration length than the lift path of the main stage valve body (27).

8. The adjustable damping valve arrangement according to claim 3, wherein said valve seat surface (39) comprises a valve seat ring; and wherein said valve seat ring (31) is adjustable in an axial position relative to said damping valve housing (9).
